(19) United States
(12) Patent Application Publication
(10) Pub. No.: US 2024/0119023 A1
(43) Pub. Date: Apr. 11, 2024

(54) MULTICORE SYSTEM AND METHOD FOR COMMUNICATION WITHIN THE SAME

(71) Applicant: MITAC COMPUTING TECHNOLOGY CORPORATION, Taoyuan City (TW)

(72) Inventors: Cyuan-Yong GAN, Taoyuan City (TW); Yi LIN, Taoyuan City (TW)

(21) Appl. No.: 18/308,018

(22) Filed: Apr. 27, 2023

(30) Foreign Application Priority Data
Oct. 6, 2022 (TW) 111138022

(51) Int. Cl. G06F 15/173

(52) U.S. Cl. CPC G06F 15/17337

(57) ABSTRACT

A method for communication within a multicore system which includes a primary programmable logic device (PLD) and a secondary PLD installed respectively on a primary motherboard and a secondary motherboard includes steps of: A) by the primary PLD, determining whether the primary motherboard is connected to the secondary motherboard; B) by the primary PLD, after determining that the primary motherboard is connected to the secondary motherboard, sending a reply-requesting signal to the secondary PLD; C) by the secondary PLD, after receiving the reply-requesting signal, sending a reply signal corresponding to the reply-requesting signal to the primary PLD; D) by the primary PLD, after receiving the reply signal, sending an instruction to the secondary PLD; and E) by the secondary PLD, after receiving the instruction, performing an operation corresponding to the instruction.

### CROSS-REFERENCE TO RELATED APPLICATION

This application claims priority to Taiwanese Invention Patent Application No. 111138022, filed on Oct. 6, 2022.

### FIELD

The disclosure relates to a multicore system including multiple motherboards, and more particularly to intercommunication between the motherboards of a multicore system.

### BACKGROUND

A size of a motherboard of a multicore system is limited by the dimensions of a cabinet accommodating the system. Therefore, for example, when a four-core system is to be accommodated in a standard cabinet, two motherboards, on each of which two processor cores are disposed, will be needed, since a single motherboard carrying all four processor cores would be too large to fit in the cabinet.

In a conventional multicore system including two or more motherboards, a large number of cables are required for connecting the motherboards, in order to enable signal communication between/among the motherboards that is necessary for normal operation of the system. For example, in a conventional multicore system including two motherboards, a complex programmable logic device for controlling a power sequence when booting the system is disposed on only one of the motherboards, and at least forty pins for the cables are required on each motherboard for communication of all control signals related to the power sequence between the motherboards. The mass of the cables and the pins increase both the cost of and the difficulty in assembling the system.

### SUMMARY

Therefore, an object of the disclosure is to provide a multicore system and a method for communication within the multicore system that can alleviate at least one of the drawbacks of the prior art.

According to the disclosure, the multicore system includes a primary motherboard and a secondary motherboard. The primary motherboard includes a primary programmable logic device (PLD). The secondary motherboard includes a secondary PLD that is to be electrically connected to said first PLD. The primary PLD is configured to determine whether the primary motherboard is connected to the secondary motherboard. The primary PLD is configured to send a reply-requesting signal to the secondary PLD after determining that the primary motherboard is connected to the secondary motherboard. The primary PLD is configured to send an instruction to the secondary PLD after receiving a reply signal from the secondary PLD. The second PLD is configured to send the reply signal corresponding to the reply-requesting signal to the primary PLD after receiving the reply-requesting signal from the primary PLD. The second PLD is configured to perform an operation corresponding to the instruction after receiving the instruction from the primary PLD.

According to the disclosure, the method for communication within the multicore system that includes the primary motherboard and the secondary motherboard, on which the primary PLD and a secondary PLD 21 are installed, includes following steps: A) by the primary PLD, determining whether the primary motherboard is connected to the secondary motherboard; B) by the primary PLD, after determining that the primary motherboard is connected to the secondary motherboard, sending a reply-requesting signal to the secondary PLD; C) by the secondary PLD, after receiving the reply-requesting signal from the primary PLD, sending a reply signal corresponding to the reply-requesting signal to the primary PLD; D) by the primary PLD, after receiving the reply signal from the secondary PLD, sending an instruction to the secondary PLD; and E) by the secondary PLD, after receiving the instruction from the primary PLD, performing an operation corresponding to the instruction.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram that exemplarily illustrates a multicore system according to an embodiment of the disclosure.

FIG. 2 is a flow chart that exemplarily illustrates a first portion of a method for communication within the multicore system according to an embodiment of the disclosure.

FIG. 3 is a flow chart that exemplarily illustrates a second portion of the method according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

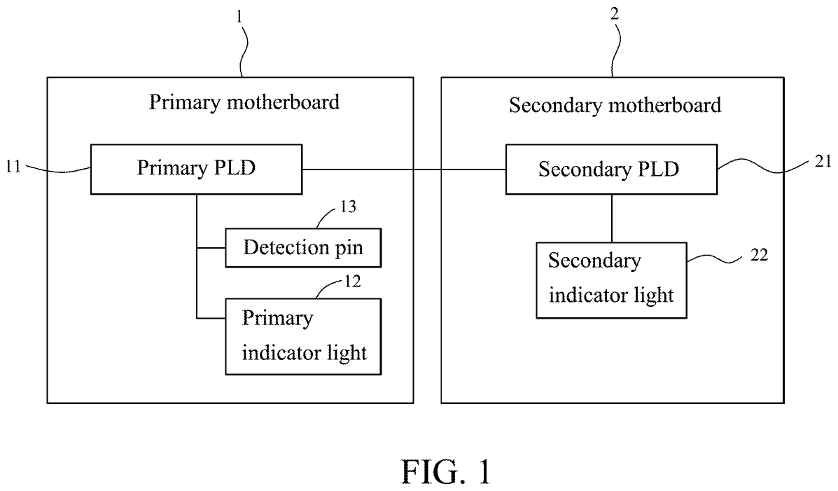

FIG. 1 illustrates a multicore system according to an embodiment of the disclosure. The multicore system includes a primary motherboard 1 and a secondary motherboard 2, wherein each of the primary motherboard 1 and the secondary motherboard 2 has at least one processor core installed thereon. The primary motherboard 1 and the secondary motherboard 2 are configured to be electrically connected to each other through at least one primary pin on the primary motherboard 1, at least one secondary pin on the secondary motherboard 2, and a transmission interface (not shown in FIG. 1) connecting between the primary pin(s) and the secondary pin(s). According to some embodiments, the transmission interface may be implemented by a serial general purpose input/output (SGPIO) bus, at least one general purpose input/output (GPIO) bus, an Inter-Integrated Circuit (I²C) bus, a System Management Bus (SMBus), a Universal Asynchronous Receiver/Transmitter (UART), at least one conducting wire, etc. In an embodiment where the transmission interface between the primary motherboard 1 and the secondary motherboard 2 is an SGPIO bus, the primary motherboard 1 and the secondary motherboard 2 are configured to be electrically connected to each other through four conducting wires, each of which is connected to a respective one of four primary pins on the primary motherboard 1 and a respective one of four secondary pins on the secondary motherboard 2.

A primary programmable logic device (PLD) 11 and a secondary PLD 21 are installed on the primary motherboard 1 and the secondary motherboard 2, respectively. Each of the primary PLD 11 and the secondary PLD 21 may be a complex programmable logic device (CPLD). The primary PLD 11 and the secondary PLD 21 are adapted to be electrically connected to each other through the transmission interface. The primary PLD 11 is configured to perform a primary power sequence that is related to the primary motherboard 1 and that includes plural primary power-on stages. The secondary PLD 21 is configured to perform a secondary power sequence that is related to the secondary motherboard 2 and that includes plural secondary power-on stages which respectively correspond to the plural primary power-on stages.

The primary motherboard 1 includes a detection pin 13 that is one of the primary pin(s) and that is electrically connected to the primary PLD 11. The detection pin 13 is configured to be at a first logic level when the primary motherboard 1 is connected to the secondary motherboard 2 (that is, electrically connected to the secondary motherboard 2 through the transmission interface), or otherwise, at a second logic level. In an embodiment, the first logic level is low, and the second logic level is high.

The primary motherboard 1 further includes a primary indicator light 12 that is electrically connected to the primary PLD 11. The secondary motherboard 2 further includes a secondary indicator light 22 that is electrically connected to the secondary PLD 21. The primary indicator light 12 and the secondary indicator light 22 are configured to flash under control of the primary PLD 11 and the secondary PLD 21, respectively.

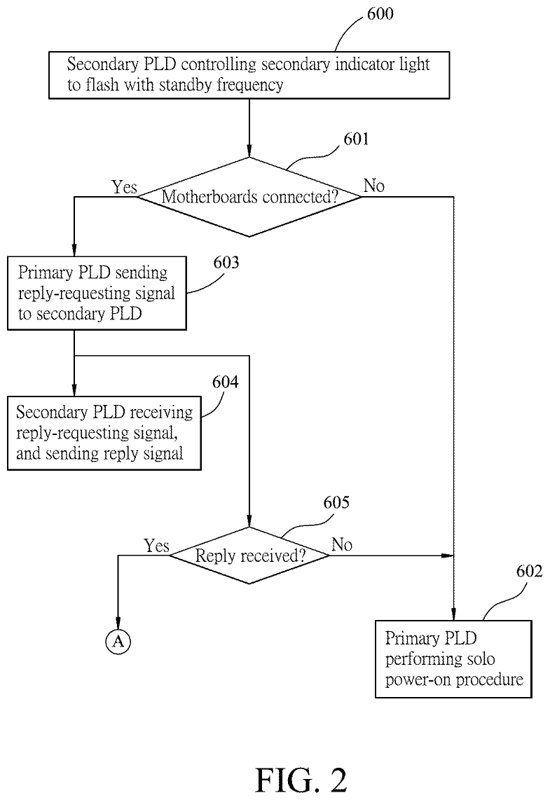

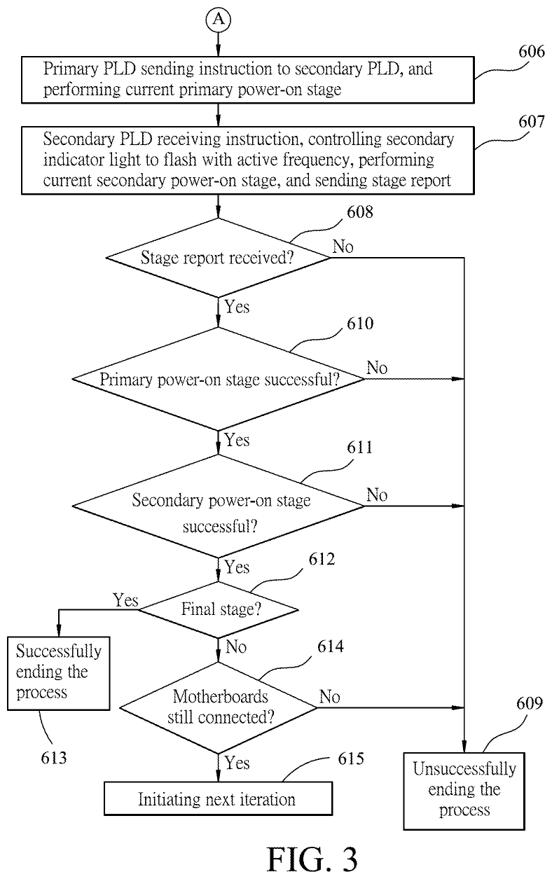

FIGS. 2 and 3 illustrate a method according to an embodiment of the disclosure. The method is to be performed by the multicore system for communication within the multicore system. Specifically, a first portion of the method that is related to confirmation on signal transmission between the primary motherboard 1 and the secondary motherboard 2 is illustrated in FIG. 2, and a second portion of the method that is related to a power sequence for booting the multicore system is illustrated in FIG. 3.

Referring to FIG. 2, the first portion of the method includes steps 600-605.

In step 600, the secondary PLD 21 controls the secondary indicator light 22 to continuously flash with a standby frequency. In an embodiment, the standby frequency is 4 Hz, but the disclosure is not limited thereto.

In step 601, the primary PLD 11 determines, through the detection pin 13, whether the primary motherboard 1 is connected to the secondary motherboard 2. When it is determined that the primary motherboard 1 is connected to the secondary motherboard 2, the process goes to step 603; otherwise, the process goes to step 602. Specifically, the primary PLD 11 detects whether the detection pin 13 is at the first logic level. When it is detected that the detection pin 13 is at the first logic level, the primary PLD 11 determines that the primary motherboard 1 is connected to the secondary motherboard 2. When it is detected that the detection pin 13 is not at the first logic level (i.e., the detection pin 13 is at the second logic level), the primary PLD 11 determines that the primary motherboard 1 is not connected to the secondary motherboard 2.

In step 602, the multicore system performs a solo power-on procedure that is only related to the primary motherboard 1 and not related to the secondary motherboard 2, so that the multicore system operates only with the primary motherboard 1 after the solo power-on procedure is completed. Specifically, the primary PLD 11 controls the primary indicator light 12 to flash with an active frequency that is different from the standby frequency, and performs, independently of the secondary motherboard 2, the primary power sequence related to the primary motherboard 1 by sequentially performing the plural primary power-on stages of the primary power sequence, in order to initialize power module(s) (not shown) installed on the primary motherboard 1. In an embodiment, the active frequency is 1 Hz, but the disclosure is not limited thereto. It is noted that only when one of the primary power-on stages has been successfully completed will another one of the primary power-on stages that is next to said one of the primary power-on stages be performed. In an embodiment where the primary power-on sequence includes a first primary power-on stage that is related to 24V and 12V and a second primary power-on stage that is related to 5V and 3.3V, the primary PLD in the first primary power-on stage triggers initiation of a voltage regulator (transformer) of 24V, and determines that the initiation of the voltage regulator of 24V is successful when a power good signal is received from the voltage regulator of 24V. The primary PLD in the first primary power-on stage similarly triggers initiation of a voltage regulator of 12V, and determines that the initiation of the voltage regulator of 12V is successful when a power good signal is received from the voltage regulator of 12V. When both of the power good signals from the voltage regulator of 24V and the voltage regulator of 12V are received, the primary PLD determines that the first primary power-on stage has been successfully completed, and proceeds to perform the second primary power-on stage. According to some embodiments, operations related to the primary power-on stages may include initiation of various devices such as a memory device, a central processing unit (CPU), a network interface card, etc., and determination as to whether the primary power-on stages are successfully completed may be based on whether predetermined signals respectively related to the various devices are received from the various devices.

In step 603, the primary PLD 11 sends a reply-requesting signal to the secondary PLD 21 through a first primary pin that is one of the primary pin(s) on the primary motherboard 1. The first primary pin is adapted to be connected to a first conducting wire connecting the first primary pin and a first secondary pin that is one of the secondary pin(s) on the secondary motherboard 2.

In step 604, the secondary PLD 21 receives the reply-requesting signal from the primary PLD 11 through the first secondary pin on the secondary motherboard 2, and sends a reply signal corresponding to the reply-requesting signal to the primary PLD 11 through a second secondary pin that is one of the secondary pin(s) on the secondary motherboard 2. According to some embodiments, the second secondary pin may be the same as or different from the first secondary pin. In an embodiment where the transmission interface between the primary motherboard 1 and the secondary motherboard 2 is an SGPIO bus, the second secondary pin is different from the first secondary pin and is adapted to be connected to a second conducting wire connecting the second secondary pin and a second primary pin that is one of the primary pin(s) on the primary motherboard 1 other than the first primary pin. Furthermore, in said embodiment, the reply-requesting signal is a bit with a particular value, and the reply signal is the same as the reply-requesting signal, i.e., the reply signal is also a bit with the particular value.

In step 605, the primary PLD 11 determines whether a reply (i.e., the reply signal) in response to the reply-requesting signal is received from the secondary PLD 21 through the second primary pin on the primary motherboard 1. When it is determined that the reply in response to the reply-requesting signal is received, the process continues to the second portion of the method (illustrated in FIG. 3) to perform a joint power-on procedure that is related to both the primary motherboard 1 and the secondary motherboard 2; otherwise, the process goes to step 602. In some embodiments, the primary PLD 11 is to determine that no reply in response to the reply-requesting signal is received from the secondary PLD 21 when no reply signal from the secondary PLD 21 has been received after a time period of a predetermined length (e.g., one second) has elapsed since the primary PLD 11 sent the reply-requesting signal to the secondary PLD 21 in step 603.

It is noted that in some embodiments of the disclosure, the process does not directly go to step 602 when it is determined, in step 605, that no reply in response to the reply-requesting signal is received. According to some embodiments, when it is determined, in step 605, that no reply in response to the reply-requesting signal is received, the process may first go back to step 603 for the primary PLD 11 to send the reply-requesting signal to the secondary PLD 21 once again, and then go to step 602 only after the determination of no reply has been made a predetermined number (e.g., three) of times.

The second portion of the method that includes steps 606-615 are illustrated in FIG. 3 and are to be performed with respect to each of the primary power-on stages (of the primary power sequence related to the primary motherboard 1) and the corresponding one of the secondary power-on stages (of the secondary power sequence related to the secondary motherboard 2). The second portion of the method illustrated in FIG. 3 is also referred to as the joint power-on procedure. In the following description, one of the plural primary power-on stages and the corresponding one of the plural secondary power-on stages which an iteration of the joint power-on procedure is performed with respect to are also referred to as “current primary power-on stage” and “current secondary power-on stage,” respectively.

In step 606, the primary PLD 11 sends an instruction to the secondary PLD 21 to initiate the current secondary power-on stage that is to be performed by the secondary PLD 21, and performs the current primary power-on stage, so that the current primary power-on stage and the current secondary power-on stage may both be performed in this iteration of the joint power-on procedure.

In step 607, the secondary PLD 21 receives the instruction from the primary PLD 11, and performs an operation corresponding to the instruction. Specifically, the secondary PLD 21 controls the secondary indicator light 22 to flash with the active frequency, performs the current secondary power-on stage, and sends a stage report to the primary PLD 11 after finishing the current secondary power-on stage. The stage report indicates whether the current secondary power-on stage has been successfully completed. The secondary indicator light 22 flashing with the active frequency enables a user of the multicore system to visually perceive that the primary motherboard 1 and secondary motherboard 2 are being properly connected and that the joint power-on procedure is currently being performed. In an embodiment, the stage report is a particular bit (e.g., the third bit) in a bit stream. The particular bit having one value which is selected from 1 and 0 indicates that the current secondary power-on stage has been successfully completed, and the particular bit having the other value of 1 and 0 indicates the opposite.

In step 608, the primary PLD 11 determines whether the stage report is received from the secondary PLD 21. When it is determined that the stage report is received, the process goes to step 610; otherwise, the process goes to step 609. In some embodiments, the primary PLD 11 is to determine that the stage report is received only when the stage report is received within a predetermined time period (e.g., one minute) since the primary PLD 11 sent the instruction to the secondary PLD 21 in step 607.

In step 609, both of the primary power sequence on the primary motherboard 1 and the secondary power sequence on the secondary motherboard 2 fail, and the method is terminated.

In step 610, the primary PLD 11 determines whether the current primary power-on stage has been successfully completed. When it is determined that the current primary power-on stage has been successfully completed, the process goes to step 611; otherwise, the process goes to step 609. It is noted that it is not necessary for step 610 to be performed after step 608. The order of execution of steps 608 and 610 may be swapped. According to some embodiments, the primary PLD 11 may record a result of the determination (e.g., along with information related to the current primary power-on stage and execution result of the current primary power-on stage).

In step 611, the primary PLD 11 determines whether the current secondary power-on stage has been successfully completed based on the stage report received from the secondary PLD 21. When it is determined that the current secondary power-on stage has been successfully completed, the process goes to step 612; otherwise, the process goes to step 609. According to some embodiments, the primary PLD 11 may record a result of the determination (e.g., along with information related to the current secondary power-on stage and execution result of the current secondary power-on stage). According to some embodiments, the primary PLD 11 may further generate and record an integrated determination result indicating whether both of the current primary power-on stage and the current secondary power-on stage have been successfully completed.

It is noted that the process may not necessarily go to step 609 when it is determined, in step 611, that the current secondary power-on stage was not successfully completed (i.e., failed). According to some embodiments, the process may go to step 602 instead to perform the solo power-on procedure that is only related to the primary motherboard 1 and not related to the secondary motherboard 2.

In step 612, the primary PLD 11 determines whether the current primary power-on stage is a final one of the plural primary power-on stages. When it is determined that the current primary power-on stage is the final one of the plural primary power-on stages, the process goes to step 613; otherwise, the process goes to step 614.

In step 613, both of the primary power sequence on the primary motherboard 1 and the secondary power sequence on the secondary motherboard 2 have been successfully completed, and the method is terminated.

In step 614, the primary PLD 11 checks if the primary motherboard 1 is connected to the secondary motherboard 2 by once again determining whether the primary motherboard 1 is connected to the secondary motherboard 2 through the detection pin 13. When it is determined that the primary motherboard 1 is connected to the secondary motherboard 2, the process goes to step 615; otherwise, the process goes to step 609.

In step 615, the process continues to initiate another iteration of the joint power-on procedure with respect to another one of the plural primary power-on stages that is next to the current primary power-on stage and the corresponding one of the plural secondary power-on stages, which would be next to the current secondary power-on stage. That is to say, step 606 and its subsequent steps as illustrated in FIG. 3 are to be performed once again with respect to a different pair of primary and secondary power-on stages.

The multicore system and the method as provided by the disclosure utilize two PLDs (including a primary PLD and a secondary PLD) that are disposed respectively on two motherboards (including a primary motherboard and a secondary motherboard), wherein timing and synchronization of the power sequences related to the two motherboards are controlled by only one of the PLDs (i.e., the primary PLD 11 on the primary motherboard 1). It can be appreciated that by utilizing the two PLDs to confirm connection and signal communication between the two motherboards in the manner as given by the steps of the method, the number of conducting wires required for connecting two motherboards (and the number of pins on each motherboard, which correspond to the conducting wires) may be significantly reduced. According to some embodiments, the number of conducting wires (and the number of the pins on each motherboard) may be reduced to four or less. The reduced number of the conducting wires and the pins beneficially reduces the cost of and the difficulty in assembling the multicore system.

The multicore system and the method provided by the disclosure are also beneficial in that the secondary PLD sends a stage report to the primary PLD each time a secondary power-on stage is completed, so it is easy to find out, when the secondary power sequence fails, the stage where things go wrong by tracking the stage report(s) the primary PLD has received. Furthermore, the indicator lights of the motherboards that are controlled to flash with different frequencies visualize connection between the motherboards and/or progresses of the power sequences related to the motherboards. With these features, error detection and maintenance when one or both of the power sequences fail are facilitated.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for communication within a multicore system, the multicore system including a primary motherboard and a secondary motherboard, on which a primary programmable logic device (PLD) and a secondary PLD are installed, respectively, the primary PLD and the secondary PLD to be electrically connected to each other, the method comprising steps of:
A) by the primary PLD, determining whether the primary motherboard is connected to the secondary motherboard;
B) by the primary PLD, after determining that the primary motherboard is connected to the secondary motherboard, sending a reply-requesting signal to the secondary PLD;
C) by the secondary PLD, after receiving the reply-requesting signal from the primary PLD, sending a reply signal corresponding to the reply-requesting signal to the primary PLD;
D) by the primary PLD, after receiving the reply signal from the secondary PLD, sending an instruction to the secondary PLD; and
E) by the secondary PLD, after receiving the instruction from the primary PLD, performing an operation corresponding to the instruction.

2. The method as claimed in claim 1, wherein in step A), the primary PLD is to determine whether the primary motherboard is connected to the secondary motherboard through a detection pin that is disposed on the primary motherboard and that is electrically connected to the primary PLD.

3. The method as claimed in claim 2, wherein in step A), the primary PLD is to determine whether the primary motherboard is connected to the secondary motherboard based on a logic level of the detection pin, the detection pin being at a first logic level when the primary motherboard is connected to the secondary motherboard, or otherwise, at a second logic level.

4. The method as claimed in claim 1, the primary PLD being configured to perform a primary power sequence related to the primary motherboard, the secondary PLD being configured to perform a secondary power sequence related to the secondary motherboard, the primary power sequence including plural primary power-on stages, the secondary power sequence including plural secondary power-on stages that respectively correspond to the plural primary power-on stages, the method comprising a joint power-on procedure that is to be performed with respect to each of the primary power-on stages and the corresponding one of the secondary power-on stages and that includes step D) and step E), wherein in an iteration of the joint power-on procedure with respect to one of the plural primary power-on stages and the corresponding one of the plural secondary power-on stages:
in step D), the primary PLD performs the one of the plural primary power-on stages of the primary power sequence related to the primary motherboard, and sends the instruction to the secondary PLD to initiate the corresponding one of the plural secondary power-on stages of the secondary power sequence related to the secondary motherboard; and
in step E), the secondary PLD, after receiving the instruction from the primary PLD, performs the corresponding one of the plural secondary power-on stages of the secondary power sequence, and sends a stage report to the primary PLD after finishing the corresponding one of the plural secondary power-on stages, the stage report indicating whether the corresponding one of the plural secondary power-on stages has been successfully completed.

5. The method as claimed in claim 4, wherein the joint power-on procedure further includes following steps that are to be performed after step E):
F) by the primary PLD, determining whether the one of the plural primary power-on stages performed in step D) has been successfully completed;
G) by the primary PLD, after determining that the one of the plural primary power-on stages has been successfully completed and after receiving the stage report from the secondary PLD, determining whether the corresponding one of the plural secondary power-on stages performed in step E) has been successfully completed based on the stage report;
H) by the primary PLD, after determining that the corresponding one of the plural secondary power-on stages has been successfully completed, determining whether the one of the plural primary power-on stages performed in step D) is a final one of the plural primary power-on stages of the primary power sequence;
I) by the primary PLD, after determining that the one of the plural primary power-on stages is not the final one of the plural primary power-on stages, determining if the primary motherboard is connected to the secondary motherboard; and
J) after it is determined that the primary motherboard is connected to the secondary motherboard, initiating another iteration of the joint power-on procedure with respect to another one of the plural primary power-on stages that is next to the one of the plural primary power-on stages and one of the plural secondary power-on stages that is next to the corresponding one of the plural secondary power-on stages.

6. The method as claimed in claim 1, further comprising a following step that is to be performed after step A):
K) by the primary PLD, after determining that the primary motherboard is not connected to the secondary motherboard, sequentially performing plural primary power-on stages of a primary power sequence that is related to the primary motherboard.

7. The method as claimed in claim 6, the primary PLD being electrically connected to a primary indicator light, wherein:
in step K), the primary PLD further controls the primary indicator light to flash with an active frequency.

8. The method as claimed in claim 1, further comprising following steps that are to be performed after step B):
L) by the primary PLD, determining whether a reply in response to the reply-requesting signal is received from the secondary PLD; and
M) by the primary PLD, after determining that no reply in response to the reply-requesting signal is received from the secondary PLD, sequentially performing plural primary power-on stages of a primary power sequence that is related to the primary motherboard.

9. The method as claimed in claim 8, wherein in step L), the primary PLD is to determine that no reply in response to the reply-requesting signal is received from the secondary PLD after a predetermined time period, during which no reply signal from the secondary PLD is received, has elapsed since the primary PLD sent the reply-requesting signal to the secondary PLD in step B).

10. The method as claimed in claim 1, the secondary PLD being electrically connected to a secondary indicator light, the method further comprising a following step that is to be performed before step A):
N) by the secondary PLD, controlling the secondary indicator light to flash with a standby frequency.

11. The method as claimed in claim 10, wherein:
in step E), the secondary PLD, after receiving the instruction from the primary PLD, further controls the secondary indicator light to flash with an active frequency that is different from the standby frequency.

12. The method as claimed in claim 1, wherein:
in step B), the primary PLD is to send the reply-requesting signal that is a bit with a particular value; and
in step C), the secondary PLD is to send the reply signal that is a bit with the particular value.

13. A multicore system, comprising:
a primary motherboard including a primary programmable logic device (PLD); and
a secondary motherboard including a secondary PLD that is to be electrically connected to said first PLD,
wherein said primary PLD is configured to:
determine whether said primary motherboard is connected to said secondary motherboard;
send a reply-requesting signal to said secondary PLD after determining that said primary motherboard is connected to said secondary motherboard; and
send an instruction to said secondary PLD after receiving a reply signal from the secondary PLD,
wherein said second PLD is configured to:
send the reply signal corresponding to the reply-requesting signal to said primary PLD after receiving the reply-requesting signal from said primary PLD; and
perform an operation corresponding to the instruction after receiving the instruction from said primary PLD.

14. The multicore system as claimed in claim 13, further comprising:
a detection pin that is disposed on said primary motherboard and that is electrically connected to said primary PLD,
wherein said primary PLD is configured to determine whether said primary motherboard is connected to said secondary motherboard through said detection pin.

15. The multicore system as claimed in claim 13, wherein:
said primary PLD is configured to perform a primary power sequence related to said primary motherboard, the primary power sequence including plural primary power-on stages,
said secondary PLD is configured to perform a secondary power sequence related to said secondary motherboard, the secondary power sequence including plural secondary power-on stages that respectively correspond to the plural primary power-on stages,
said primary PLD is configured to perform one of the plural primary power-on stages of the primary power sequence related to the primary motherboard, and send the instruction to said secondary PLD to initiate one of the plural secondary power-on stages of the secondary power sequence related to said secondary motherboard that corresponds to the one of the plural primary power-on stages, and
said secondary PLD is configured to, after receiving the instruction from said primary PLD, perform the one of the plural secondary power-on stages of the secondary power sequence, and send a stage report to said primary PLD after finishing the one of the plural secondary power-on stages, the stage report indicating whether the one of the plural secondary power-on stages has been successfully completed.

16. The multicore system as claimed in claim 15, wherein said primary PLD is further configured to:
determine whether the one of the plural primary power-on stages has been successfully completed;
after determining that the one of the plural primary power-on stages has been successfully completed and after receiving the stage report from said secondary PLD, determine whether the one of the plural secondary power-on stages has been successfully completed based on the stage report;
after determining that the one of the plural secondary power-on stages has been successfully completed, determine whether the one of the plural primary power-on stages is a final one of the plural primary power-on stages of the primary power sequence;
after determining that the one of the plural primary power-on stages is not the final one of the plural primary power-on stages, determine if said primary motherboard is connected to said secondary motherboard; and
after it is determined that said primary motherboard is connected to said secondary motherboard, perform another one of the plural primary power-on stages of the primary power sequence that is next to the one of the plural primary power-on stages, and send another instruction to said secondary PLD to initiate another one of the plural secondary power-on stages of the secondary power sequence that corresponds to the another one of the plural primary power-on stages.

17. The multicore system as claimed in claim 13, wherein said primary PLD is further configured to:
after determining that said primary motherboard is not connected to said secondary motherboard, sequentially perform plural primary power-on stages of a primary power sequence that is related to said primary motherboard.

18. The multicore system as claimed in claim 17, further comprising:
a primary indicator light that is electrically connected to said primary PLD;
wherein said primary PLD is further configured to, after determining that said primary motherboard is not connected to said secondary motherboard, control said primary indicator light to flash with an active frequency.

19. The multicore system as claimed in claim 13, wherein said primary PLD is further configured to:
determine whether a reply in response to the reply-requesting signal is received from said secondary PLD; and
after determining that no reply in response to the reply-requesting signal is received from said secondary PLD, sequentially perform plural primary power-on stages of a primary power sequence that is related to said primary motherboard.

20. The method as claimed in claim 1, further comprising:
a secondary indicator light that is electrically connected to said secondary PLD,
wherein said secondary PLD is further configured to:
initially control said secondary indicator light to flash with a standby frequency; and
after receiving the instruction from said primary PLD, control said secondary indicator light to flash with an active frequency that is different from the standby frequency.
